(19) United States
(12) Patent Application Publication
(10) Pub. No.: US 2024/0063585 A1
(43) Pub. Date: Feb. 22, 2024

(54) DATA COMMUNICATION SYSTEM

(71) Applicant: SAMTEC, INC., New Albany, IN (US)

(72) Inventors: Jignesh H. SHAH, New Albany, IN (US); Gustavo BLANDO, New Albany, IN (US); Jean Karlo WILLIAMS BARNETT, New Albany, IN (US)

(21) Appl. No.: 18/260,024

(22) PCT Filed: Dec. 30, 2021
(86) PCT No.: PCT/US2021/065741

§ 371 Date: Jun. 29, 2023

Related U.S. Application Data
(60) Provisional application No. 63/131,859, filed on Dec. 30, 2020.
(60) Provisional application No. 63/177,826, filed on Apr. 21, 2021.
(60) Provisional application No. 63/247,785, filed on Sep. 23, 2021.
(60) Provisional application No. 63/248,224, filed on Sep. 24, 2021.

(51) Int. Cl. H01R 13/6591; H01R 12/71; H01R 13/6463; H01R 13/6471

(52) U.S. Cl. CPC H01R 13/65912; H01R 12/716; H01R 13/6463; H01R 13/6471

(57) ABSTRACT

An electrical connector includes a connector housing and a plurality of electrical contacts supported by the connector housing. The electrical contacts are oriented oblique to a mounting interface of the connector housing that mounts to an underlying substrate. The electrical connector can further include a plurality of electrical cables mounted to the electrical contacts. The electrical cables can extend from the electrical contacts along a direction oblique to the mounting interface.

### CROSS-REFERENCE TO RELATED APPLICATIONS

This application claims the benefit of U.S. Provisional Patent Application Nos. 63/131,859 filed Dec. 30, 2020 entitled “Data Communication System”; 63/177,826 filed Apr. 21, 2021 entitled “Data Communication System”; 63/247,785 filed Sep. 23, 2021 entitled “Data Communication System”; and 63/248,224 filed Sep. 24, 2021 entitled “Data Communication System”, each of which is incorporated by reference herein in its entirety.

### BACKGROUND

Electrical connectors typically include an electrically insulative connector housing and a plurality of electrical contacts supported by the connector housing. The electrical contacts typically define mounting ends and mating ends opposite the mounting ends. The mounting ends are often configured to be mounted to a first complementary electrical device, such as a printed circuit board (PCB), electrical cable, or the like. The mating ends can be configured to mate with a second complementary electrical device, such as a complementary electrical connector. Often, the mating ends define a separable interface with complementary electrical contacts of the complementary electrical connector.

Conventional electrical connectors include vertical connectors whereby the mating ends and mounting ends of the electrical contacts are aligned with each other, and right-angled electrical connectors whereby the mating ends and mounting ends of the electrical contacts are oriented generally perpendicular to each other.

### SUMMARY

In one aspect of the present disclosure, an electrical connector includes a connector housing having a mounting interface that is configured to face an underlying substrate, and a cable interface oriented perpendicular to the mounting interface. A plurality of electrical cables can be configured to exit the electrical connector at the cable interface. The electrical connector can further include a plurality of electrical contacts supported by the connector housing. The electrical contacts can have respective mounting ends configured to be mounted to the substrate, and cable attachment ends configured to attach to electrical cables, respectively. The electrical contacts can extend along respective paths from the respective mounting ends to the respective cable attachment ends, and the paths are oblique to each of the mounting interface and the cable interface.

### BRIEF DESCRIPTION OF THE DRAWINGS

The foregoing summary, as well as the following detailed description of illustrative embodiments of the intervertebral implant of the present application, will be better understood when read in conjunction with the appended drawings. For the purposes of examples of the present disclosure, there is shown in the drawings illustrative embodiments. It should be understood, however, that the application is not limited to the precise arrangements and instrumentalities shown. In the drawings:

FIG. 1 is a top plan view of a data communication system including an IC package including an IC die mounted to an IC substrate, and a plurality of electrical connectors mounted to the IC substrate;

FIG. 2A is a perspective view of the electrical connector illustrated in FIG. 1;

FIG. 2B is another perspective view of the electrical connector illustrated in FIG. 2A;

FIG. 3A is an exploded view of a portion of the data communication system illustrated in FIG. 1, showing the electrical connector including a housing assembly and a shroud;

FIG. 3B is an exploded perspective view of the portion of the data communication system of FIG. 3A, showing the shroud mounted to the substrate;

FIG. 3C is a sectional side elevation view of the data communication system of FIG. 3B, showing the housing assembly secured to the shroud;

FIG. 4 is an exploded perspective view of the housing assembly of FIG. 3A;

FIG. 5A is an exploded perspective view of a leadframe assembly of the housing assembly of FIG. 4;

FIG. 5B is a perspective view of the leadframe assembly of FIG. 5A;

FIG. 5C is a perspective view of an electrical cable of the leadframe assembly of FIG. 5A;

FIG. 5D is a perspective view of a portion of the leadframe assembly of FIG. 5A, showing an electrical cable mounted to a ground plate;

FIG. 5E is a perspective view of a leadframe housing of the leadframe assembly of FIG. 5A;

FIG. 5F is a perspective view of a portion of the leadframe assembly of FIG. 5A, showing an electrical cable mounted to a pair of electrical signal contacts;

FIG. 6A is a perspective view of a housing body of the housing assembly of FIG. 3A;

FIG. 6B is another perspective view of the housing body of FIG. 6A;

FIG. 7 is a perspective view of a cable guide body of the housing assembly of FIG. 3A;

FIG. 8 is a sectional side elevation view of a portion of the data communication system of FIG. 1;

FIG. 9A is a sectional side elevation view of a portion of the data communication system of claim 1, shown with the electrical cables removed to illustrate a plurality of electrical contacts oriented along respective first paths;

FIG. 9B is a sectional side elevation view of a portion of the data communication system of FIG. 9A, shown including the electrical cables to illustrate the electrical cables oriented along respective second paths;

FIG. 10 is top perspective, layered view of a modified EYESPEED brand cable;

FIG. 11 is side sectional view of conventional mated connectors;

FIG. 12A is side sectional view of two mated connectors;

FIG. 12B is a top plan view of a substrate showing the footprint of some of the mated connectors of FIG. 12A;

FIG. 12C is a top plan view of a substrate showing the footprint of some of the mated connectors of FIG. 12A;

FIG. 13 is top perspective view of another embodiment of a high density, communications system;

FIG. 14 is a top perspective view of the receptacle connector and substrate of FIG. 13;

FIG. 15 is top perspective view of the cable connector and substrate of FIG. 13;

FIG. 16A is a top perspective view of a cable connector;

FIG. 16B is a perspective side view of a receptacle connector; and

FIG. 16C is a cross-sectional view of the cable connector shown in FIG. 16A mated with the receptacle connector shown in FIG. 16B.

### DETAILED DESCRIPTION

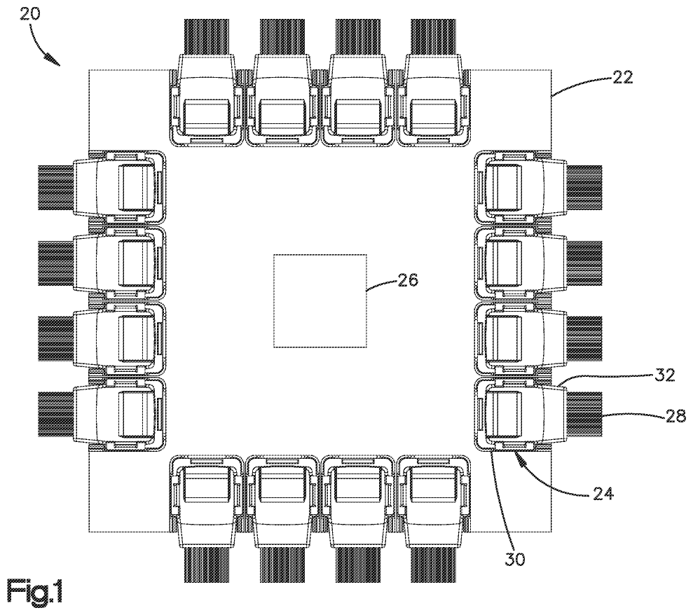

Referring to FIG. 1, a data communication system 20 includes a substrate 22 and at least one electrical connector 24, such as a plurality of electrical connectors 24, mounted to the substrate 22. It should therefore be appreciated that the electrical connectors 24 can be mounted to the same substrate 22 in one example. In one example, the substrate 22 can be configured as a printed circuit board. The data communication system 20 can further include an integrated circuit (IC) 26 mounted to the substrate 22. The integrated circuit 26 can be configured as an application specific integrated circuit (ASIC) in some examples. It is thus appreciated that an IC package can include the IC 26 configured as an IC die mounted to the substrate 22. The electrical connector 24 can include at least one electrical cable 28 such as a plurality of electrical cables 28, such that the substrate 22 places the electrical cables 28 in electrical communication with the IC 26 when the electrical connector 24 is mounted to the substrate 22.

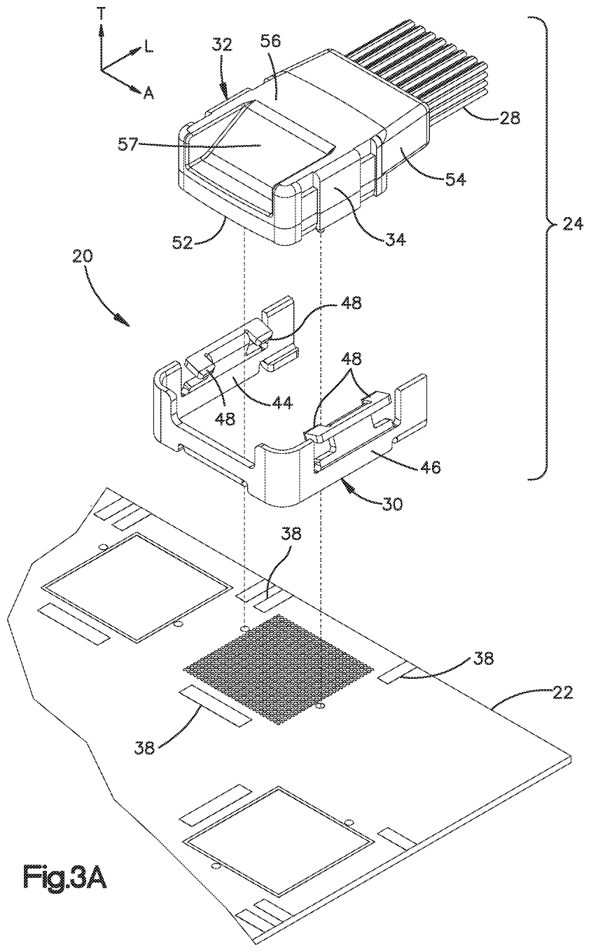

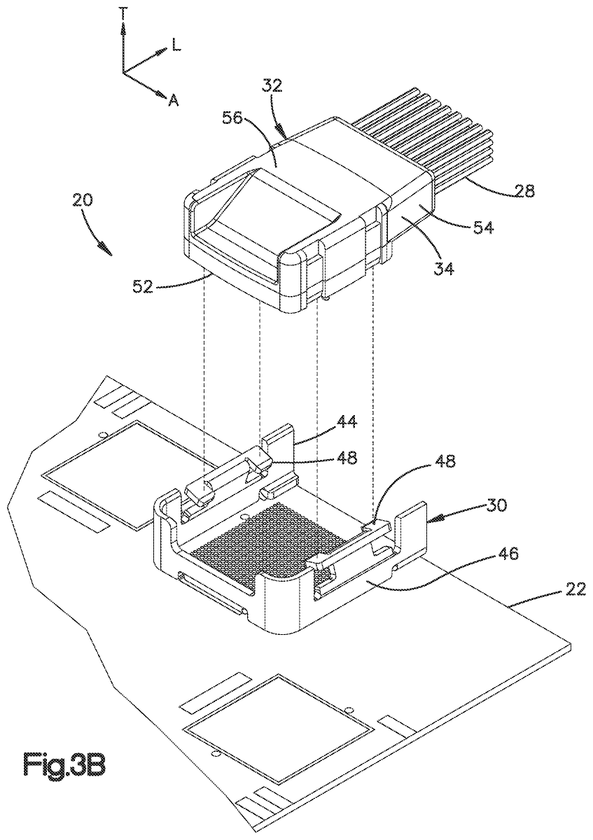

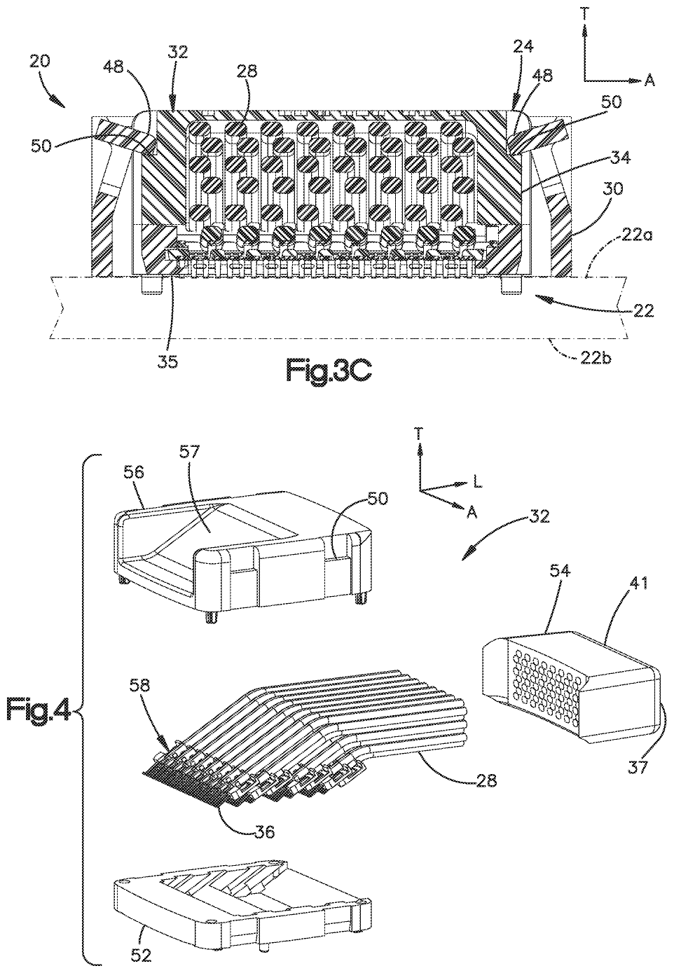

The data communication system 20 can include a plurality of electrical connectors 24 that can be mounted to the substrate 22 about an outer perimeter of the substrate 22. For instance, the electrical connectors 24 can include a first plurality of electrical connectors 24 mounted to a first surface 22a (FIG. 3C) of the substrate 22, and a second plurality of electrical connectors 24 mounted to a second surface 22b of the substrate 22 that is opposite the first surface 22a along a transverse direction T.

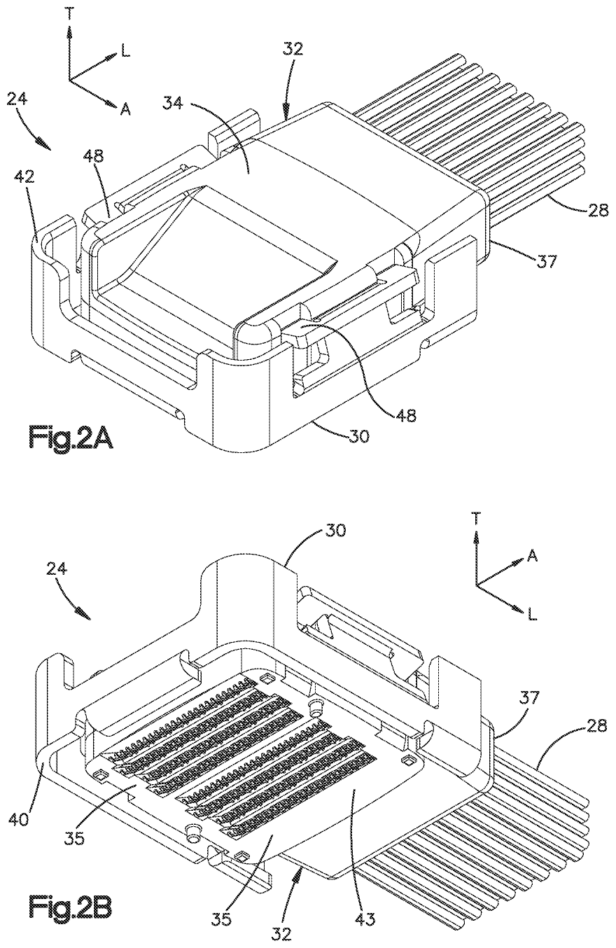

Referring now to FIGS. 2A-4, the electrical connector 24 can include a housing assembly 32 configured to be secured to a shroud 30. Alternatively, the electrical connector 24 can include the shroud 30. The housing assembly 32 can include an electrically insulative connector housing 34 and the electrical cables 28 supported by the connector housing 34. The housing assembly 32 further includes a plurality of electrical contacts 36 (FIG. 4) supported by the connector housing 34. The electrical contacts 36 can be copper, copper alloy, or phosphorus bronze and can be devoid of superelastic materials such as nitinol (NiTi). The electrical cables 28 are mounted to the electrical contacts 36, thereby placing the electrical cables 28 in electrical communication with the electrical contacts 36. The connector housing 34 defines a mounting interface 35 that is configured to face the underlying substrate 22 along the transverse direction T, and a cable interface 37 that is oriented perpendicular to the mounting interface 35. The electrical cables are configured to exit the connector housing 34 at the cable interface 37. The mounting interface 35 of the connector housing 34 can extend along a plane that is defined by a lateral direction A that is perpendicular to the transverse direction T, and a longitudinal direction L that is perpendicular to each of the lateral direction A and the transverse direction T.

The shroud 30 is configured to be mounted to the substrate 22, and the housing assembly 32 is configured to be secured to the shroud 30, thereby mounting the housing assembly 32 to the substrate 22. For instance, the shroud 30 can be soldered to mounting locations 38 of the substrate 22, or secured to the substrate 22 using mechanical fasteners, or can be mounted to the substrate 22 in any suitable alternative manner as desired. The substrate 22 can receive any one or more up to all of alignment pins, weld tabs, solder tabs, or the like so as to mount the electrical connector 24 to the substrate 22. Alternatively, or additionally, the connector housing 34 can be mounted to the underlying substrate 22. For instance, the connector housing 34 can include mechanical fasteners that are secured to the substrate 22. Alternatively, the connector housing 34 can be soldered directly to the substrate 22. Thus, in some examples, the electrical connector 24 can be devoid of the shroud 30.

In one example, the shroud 30 defines a bottom surface 40 that faces the substrate 22, and a top surface 42 opposite the lower surface 40 along the transverse direction T. The bottom surface 40 can be said to be spaced from the top surface 42 in a downward direction. Similarly, the top surface 42 can be said to be spaced from the bottom surface 40 in an upward direction. The terms “down,” “downward,” and derivatives thereof as used herein are with reference to the downward direction. The terms “up,” “upward,” and derivatives as used herein are with reference to the upward direction. The shroud 30 further defines an inner surface 44, and an outer surface 46 opposite the inner surface 44. The inner and outer surfaces 44 and 46 can be oriented substantially perpendicular to the transverse direction T. The inner surface 44 is configured to face the electrical connector 24 when the electrical connector 24 is secured to the shroud 30. For instance, the inner surface 44 can extend at least partially or entirely about the connector housing 34.

As used herein, the terms “substantially,” “approximately,” “about,” “generally,” and derivatives thereof and words of similar import as used herein recognizes that the referenced dimensions, sizes, shapes, directions, or other parameters can include the stated dimensions, sizes, shapes, directions, or other parameters and up to ±20%, including ±10%, ±5%, and ±2% of the stated dimensions, sizes, shapes, directions, or other parameters. Further, the term “at least one” stated structure as used herein can refer to either or both of a single one of the stated structures and a plurality of the stated structure. Additionally, reference herein to a singular “a,” “an,” or “the” applies with equal force and effect to a plurality unless otherwise indicated. Similarly, reference to a plurality herein applies with equal force and effect to the singular “a,” “an,” or “the.”

Referring now also to FIG. 3C, the shroud 30 and the connector housing 34 can include complementary engagement members that engage each other so as to secure the connector housing 34 to the shroud 30. For instance, the connector housing 34, and thus the housing assembly 32, can be releasably secured to the shroud 30. In one example, at least one engagement member of the shroud 30 can be configured as at least one engagement finger 48, such as a plurality of engagement fingers 48. At least one engagement member of the connector housing 34 can define at least one catch member 50 such as a plurality of catch members 50 that receives the engagement fingers 48, respectively. As the connector housing 34 is inserted into the shroud 30 in the downward direction, the engagement fingers 48 resiliently ride along the connector housing until the engagement fingers 48 seat in a respective one of the catch members 50, thereby securing the connector housing 34 to the shroud 30. The engagement fingers 48 can be urged away from the connector housing 34 when it is desired to disconnect the connector housing 34, and thus the housing assembly 32, from the shroud 30. Once the engagement fingers 48 are free from engagement with the catch members 50, the connector housing 34 can be removed from the shroud 30. In other examples, the engagement member of the connector housing 34 can include the at least one engagement finger 48, and the engagement members of the shroud can include at least one catch member 50 that receives the engagement finger 48.

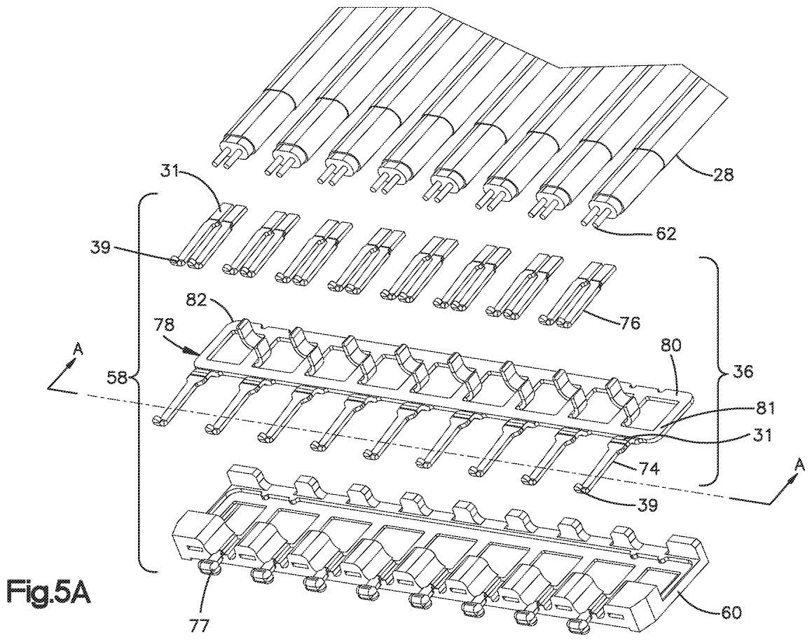

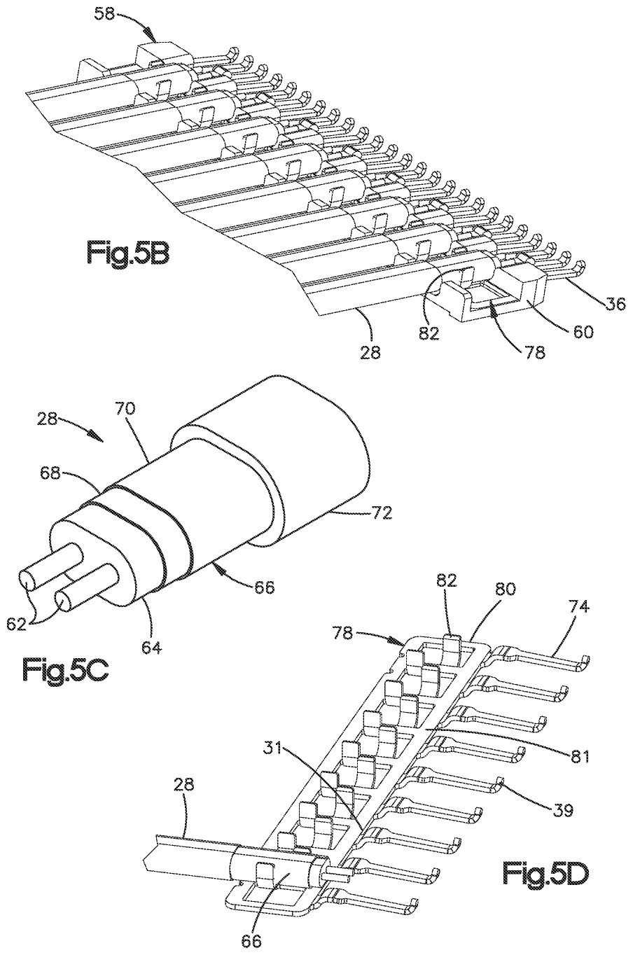

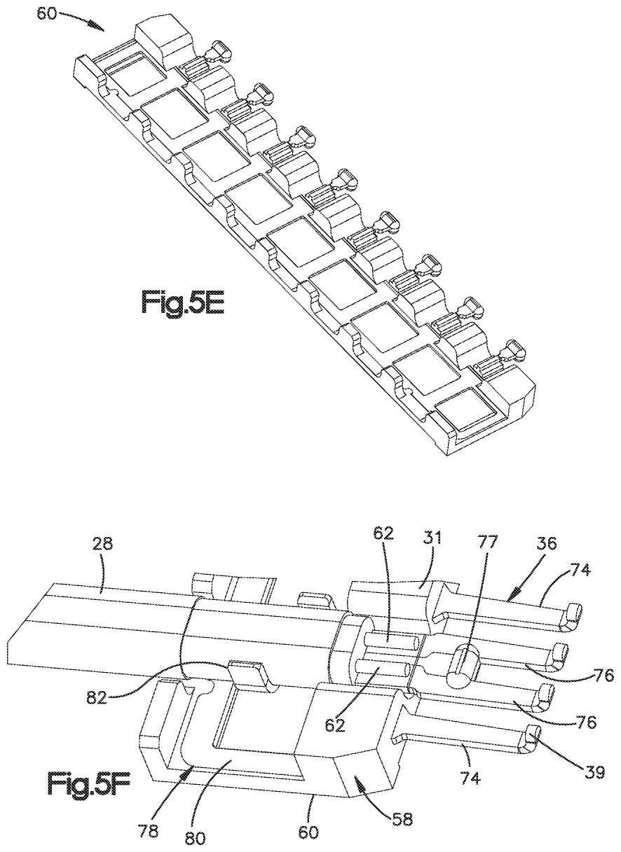

The housing assembly 32 will now be described with reference to FIGS. 4 and 5A. In one example, the connector housing 34 includes a housing body 52, a cable support body 54, and a cable guide body 56. The housing body 52 can be configured to support the electrical contacts 36. In one example, the housing assembly 32 can include a plurality of leadframe assemblies 58 that each includes a respective electrically insulative or dielectric leadframe housing 60 (FIG. 5A) and a respective plurality of the electrical contacts 36 supported by the leadframe housing 60. The electrical contacts 36 of each of the leadframe assemblies 58 can be arranged along respective rows that are spaced from each other along the longitudinal direction L. The rows can be arranged along the lateral direction A. Accordingly, the electrical contacts 36 of each of the rows can be spaced from each other along the lateral direction A. Adjacent ones of the electrical contacts 36 of each of the respective rows can be spaced from each other along the lateral direction A at any suitable center-to-center pitch. The pitch can, for instance, be in a range from approximately 0.5 mm to approximately 1.0 mm, such as approximately 0.6 mm.

The leadframe housing 60 can, in turn, be supported by the housing body 52. The cable support body 54 can support the electrical cables 28. For instance, the cable support body 54 can be insert molded onto the electrical cables 28. Alternatively, the electrical cables 28 can be inserted through apertures that extend through the cable support body 54. The cable support body 54 defines the cable interface 37. In particular, the cable interface 37 can be defined by an exterior surface 41 of the cable support body that is oriented along a plane that extends along the transverse direction T and the lateral direction A. Thus, the exterior surface 41 of the cable support body 54 is oriented perpendicular or substantially perpendicular to the mounting interface 35. The electrical cables 28 extend through the exterior surface 41 and into the connector housing 34 in a forward direction oriented along the longitudinal direction. Alternatively, the cable interface 37, or the exterior surface 41 of the cable support body 54, can be oriented obliquely relative to the mounting interface 35. Electrical cables 28 that enter the exterior surface 41 at an oblique angle may allow the electrical cables to avoid other components on the substrate.

The cable support body 54 can be secured to or be monolithic with the housing body 52. The cable guide body 56 can guide the electrical cables 28 to extend along a desired oblique path as described in more detail below. The cable guide body 56 can also define the catch members 50. Alternatively, the catch members 50 can be defined by the housing body 52. It should be appreciated that while the connector housing 34 includes the housing body 52, the cable support body 54, and the cable guide body 56 in one example, it is recognized that the connector housing 34 can be constructed in any suitable alternative manner as desired. Thus, reference to each of the housing body 52, the cable support body 54, and the cable guide body 56 applies with equal force and effect to the connector housing 34, unless otherwise indicated.

The leadframe assemblies 58 will now be described with reference to FIGS. 5A-5F. While one leadframe assembly 58 is described, the description of the leadframe assembly 58 applies to the other leadframe assemblies 58 unless otherwise indicated. The electrical contacts 36 can define respective mounting ends 39 configured to be mounted or coupled to the substrate 22, and respective cable attachment ends 31 configured to attach to the electrical cables 28, respectively. In some embodiments, the mounting ends 39 can be mounted to or fixed to the substrate 22. The mounting ends 39 extend substantially in at least one of a downward and forward direction from the mounting interface 35 (FIG. 2B) so as to couple to the underlying substrate 22. The downward direction can be oriented along the transverse direction T and the forward direction can be oriented along the longitudinal direction L.

In one example, a first at least one electrical connector 24 can be mounted to a first surface 22a of the substrate 22, and a second at least one electrical connector 24 can be mounted to a second surface 22b of the substrate 22. The first and second at least one electrical connector 24 can be aligned with each other along the transverse direction, in what is known as a belly-to-belly relationship.

The electrical cables 28, as shown in FIGS. 5A-5F and FIG. 10, can be configured as twinaxial cables having first and second electrical conductors 62, an inner dielectric material 64 that surrounds the electrical signal conductors 62 such that the signal conductors 62 are electrically isolated from each other. The electrical cables 28 can further include an electrical shield 66 that surrounds the inner dielectric material 64. The electrical shield 66 can be defined by a single electrically conductive layer 68, or by first and second electrically conductive layers 68 and 70. The electrical cables 28 can further include an outer electrically insulative jacket 72 that surrounds the electrical shield 66. In one example, the outer electrically insulative jacket 72 can be configured as an electrically insulative tape that surrounds the electrical shield 66. The tape can adhere to the electrical shield in some examples. The tape can have a reduced thickness compared to conventional outer electrically insulative jackets 72. For instance, the tape can have a thickness in a range from approximately 0.00025 inches to approximately 0.005 inches (approximately 0.00635 millimeters to approximately 0.127 millimeters).

The electrical cable 28 may have an oval or elliptical cross-sectional shape. Accordingly, the electrical cable 28 can have a height in a cross-section that is less than approximately 0.035 inches (approximately 0.889 millimeters). For example, the height can be in a range from approximately 0.025 inches to approximately 0.03 inches (approximately 0.635 millimeters to approximately 0.762 millimeters). In particular, the height can be approximately 0.027 inches (approximately 0.686 millimeters). The electrical cable can have a width perpendicular to the height in the cross-section that is less than approximately 0.055 inches (approximately 1.397 millimeters). For example, the width can be in a range from approximately 0.045 inches to approximately 0.05 inches (approximately 1.143 millimeters to approximately 1.27 millimeters). In particular, the width can be approximately 0.047 inches (approximately 1.1938 millimeters). The signal conductors 62 can be spaced from each other along a direction that defines the width, which also may be denoted as a major axis of cross-sectional shape. It should be appreciated that the twinaxial cables can be alternatively constructed as desired, for instance with or without a drain wire. A drain wire may be electrically coupled to a ground terminal such as the ground assembly 78 and to one or both of the first electrically conductive layer 68 and the second electrically conductive layer 70 along the length of the electrical cable 28 to ensure the electrical shield 66 is effectively grounded. The twinaxial cables of each leadframe assembly 58 can be arranged such that the electrical cables of each leadframe assembly are aligned with each other along a respective row. Further, the electrical conductors 62 of each of the twinaxial can be disposed adjacent each other along the respective row. Alternatively still, the electrical cables 28 can be configured as coaxial cables, waveguides, or any suitable alternative cables as desired.

The electrical contacts 36 can include a plurality of ground contacts 74 and a plurality of signal contacts 76. The ground contacts 74 of each leadframe assembly 58 can be monolithic with each other so as to define a ground assembly 78 in one example. The ground assembly 78 can include a ground plate 80, and the ground contacts 74 can extend forward from the ground plate 80. The ground plate 80 can be configured to contact the electrical shields 66 of the electrical cables 28 of the leadframe assembly 58. For instance, the ground plate 80 can include projections that can be configured to contact the electrical shields 66. In one example, the ground plate 80 can include a frame 81and the projections that extend out from the frame. The projections can be configured as cradles 82 that are configured to receive or otherwise contact respective ones of the electrical cables 28. For instance, the cradles 82 can be curved so as to receive the electrical shields 66 when the insulative jacket 72 has been removed. Without being bound by theory, a curved cradle 82 may increase the contact surface area thereby increasing electrical coupling between the cradle 82 and electrical shield 66. The projections can be otherwise configured as desired. The cradles 82 can contact the shields on one lateral side or both lateral sides of the shield. The electrical shields can further contact the ground plate 80 at the frame at a location spaced from the projections in a rearward direction opposite the forward direction. Thus, the ground plate 80, including each of the ground contacts 74 of the leadframe assembly 78, and the electrical shields 66 of each of the electrical cables 28 of the leadframe assembly 78 can be placed in electrical communication with each other. It should be appreciated that the cradles 82 can define the cable attachment ends 31 of the ground contacts 74. The leadframe housing 60 can be insert molded onto the ground plate 80, though it should be appreciated that the ground plate 80 can be supported by the leadframe housing 60 in any suitable manner as desired. It should be appreciated that the electrical ground contacts 74 can alternatively be individually supported by the ground plate 80 and placed in contact with respective electrical shields 66.

The electrical signal contacts 76 of the leadframe assembly 78 can be similarly supported by the leadframe housing 60 in any suitable manner as desired. In one example, the leadframe housing 60 can be insert molded onto the signal contacts 76. Alternatively, the signal contacts 76 can be stitched into the leadframe housing 60 or otherwise supported by the leadframe assembly as desired. The leadframe housing 60 can define spacers 77 that extend between adjacent ones of the electrical signal contacts 76 that define respective differential signal pairs. In some examples, the spacers 77 can partially or entirely support the electrical signal contacts 76. The cable attachment ends 31 of the signal contacts 76 can be placed in contact with respective ones of the signal conductors 62. The signal conductors 62 of each twinaxial cable can define differential signal pairs. Thus, adjacent ones of the electrical signal contacts 76 can define differential signal pairs. The electrical contacts 36 of the leadframe assembly 58 can be arranged in any suitable pattern as desired along the row, such as a repeating S-S-G pattern, wherein “S” designates a signal contact, and “G” designates a ground contact. It is recognized that any other pattern is envisioned, including a repeating S-S-G-G pattern. Thus, a pair of ground contacts can be disposed between adjacent differential signal pairs along the respective row. The differential signal pairs of the electrical connector 24 can be configured to transfer differential signals at data transfer rates of up to and including 56 Gigabits/second while producing no more than six percent worst-case, multi-active cross talk on a victim differential signal pair of the differential signal pairs.

The leadframe assemblies 58 can include a first plurality of leadframe assemblies and a second plurality of leadframe assemblies, alternatingly arranged with the first plurality of leadframe assemblies. The first and second leadframe assemblies can define adjacent rows. The electrical contacts of the first plurality of leadframe assemblies can be staggered along the respective rows with respect to the electrical contacts of the second plurality of leadframe assemblies in the lateral direction. Alternatively, the signal contacts and ground contacts of all of the leadframe assemblies 58 can be aligned with each other along respective planes that are oriented perpendicular to the respective rows. For example, the signal contacts and ground contacts of all of the leadframe assemblies 58 can be aligned with each other along respective planes that are oriented in the lateral direction.

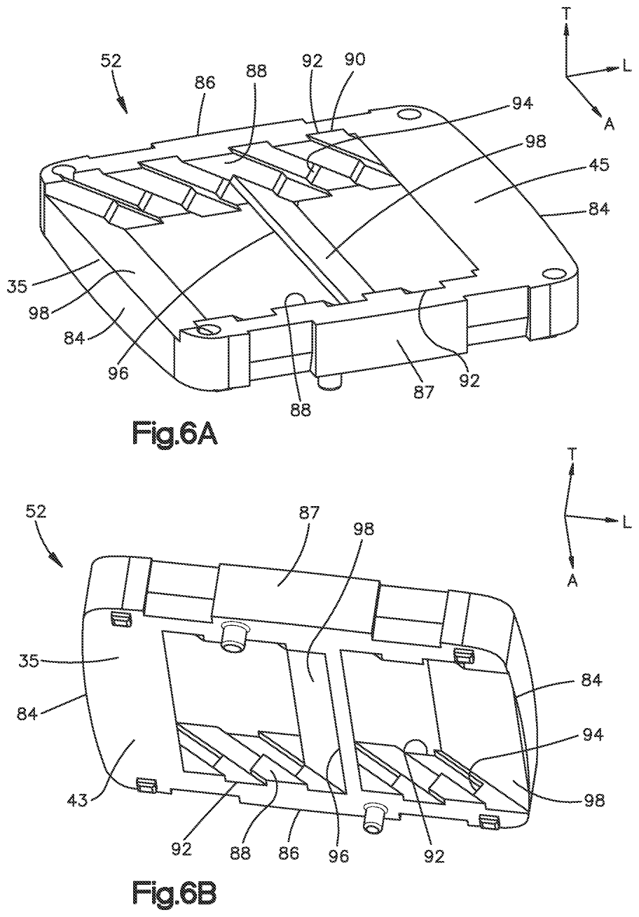

The housing body 52 will now be described in more detail with reference to FIGS. 6A-B and FIG. 8. The housing body 52 can define the mounting interface 35, and can further be configured to support the leadframe assemblies 58. The housing body 52 includes a pair of end walls 84 spaced from each other along the longitudinal direction L, and a first and second side walls 86 and 87 that extend between the end walls 84 and are spaced from each other along the lateral direction A. The housing body 52 defines the mounting interface 35. In particular, the housing body 52 defines a bottom exterior surface 43 that defines the mounting interface 35. The bottom exterior surface 43 can face the substrate 22 when the electrical connector 24 is mounted to the substrate 22. Thus, the bottom exterior surface 43 can define an exterior surface of the connector housing 34. The bottom exterior surface 43 can be defined by each of the end walls 84 and side walls 86 and 87. The housing body 52 defines a top surface 45 opposite the bottom exterior surface 43. The top surface 45 can be defined by each of the end walls 84 and side walls 86 and 87. The side walls 86 and 87 define respective inner surfaces 88 that face each other along the lateral direction A. As will now be described, the housing body 52 is configured to support the electrical contacts 36 such that the electrical contacts are elongate along a respective direction oblique to each of the longitudinal direction L and the transverse direction T.

In particular, the housing body 52 defines a plurality of support members 90 that are configured to support the leadframe assemblies 58 in the housing body 52. In particular, the support members 90 are configured to support the leadframe assemblies 58 in a predetermined oblique orientation that is oblique to each of the mounting interface 35 and the cable interface 37. Thus, the oblique orientation is oblique to each of the exterior surface 41 of the cable support body 54 and the exterior surface 43 of the housing body 52.

In one example, the support members 90 can be configured as slots 92 that extend into the side walls 86 and 87. For instance, the slots 92 can extend into the inner surfaces 88 of the side walls 86 and 87 along the lateral direction A. The slots 92 can be elongate along an oblique direction that is oblique to each of the mounting interface 35 and the cable interface 37. Thus, the oblique direction is oblique to each of the exterior surface 41 of the cable support body 54 and the exterior surface 43 of the housing body 52. In particular, the slots 92 can extend in the downward direction as they extend in the forward direction. The slots 92 can be arranged in pairs of a respective first slot 92 that extends into the first side wall 86 and a respective second slot 92 that extends into the second side wall 87. The first and second slots 92 of each pair of slots 92 can be aligned with each other along the lateral direction A.

The slots 92 can extend from the top exterior surface 45 toward the bottom exterior surface 43. The slots 92 can terminate prior to extending through the bottom exterior surface 43. Thus, the slots 92 can terminate at a stop surface 94 that is spaced upward from the bottom exterior surface. The slots 92 each have a width sufficient to receive respective ones of the leadframe assemblies 58. In particular, respective sides of the leadframe housings 60 are sized to be received in the respective first and second slots 92 of a pair of slots 92. During fabrication of the housing assembly 32, the leadframe housings 60 are driven along the slots 92 along a direction of insertion from respective openings at the top exterior surface 45 toward the bottom exterior surface 43 until the leadframe housings 60 abut the respective stop surfaces 94 in the slots 92, whereby the leadframe assemblies 58 are fully inserted in the slots 92 and thus fully seated in the connector housing 34. The mounting ends 39 of the electrical contacts 36 can extend from the leadframe housings 60 substantially in the direction of insertion when the leadframe housings 60 are inserted into the slots 92. The mounting ends 39 (FIG. 8) extend out from the mounting interface 35, and thus from the bottom exterior surface 43, when the leadframe assemblies 58 are fully inserted in the slots 92. Accordingly, when the housing assembly 32 is mounted to the substrate 22, the mounting ends 39 can be compressed against respective electrical contact pads of the substrate 22. Thus, the mounting ends 39 can define a separable interface with the substrate 22. As a result, when the connector housing assembly 32 is removed from the shroud 30, the electrical contacts 36 can be removed from the substrate 22 without damaging the electrical contacts 36, the substrate 22, or both. It should be appreciated that the mounting ends 39 can be alternatively configured to be mounted to the substrate 22 in any suitable alternative manner as desired. In one example, the mounting ends 39 can be configured as resiliently compressible spring fingers. Alternatively, the mounting ends 39 could be fixed to the substrate 22 to prevent detachment of the mounting ends 39 from the substrate 22. For example, the mounting ends 39 could be soldered or otherwise affixed to the substrate 22.

As described above, the slots 92 can be elongate from the top exterior surface 45 to the stop surface 94 along the oblique direction that is oblique to each of the mounting interface 35 and the cable interface 37. The oblique direction can therefore be oblique to the surface of the substrate 22 to which the electrical connector 24 is mounted. The slots 92 can all be substantially parallel with each other. Alternatively, the slots 92 can be oblique to each other. Accordingly, when the leadframe assemblies 58 are inserted into the slots 92, the leadframe assemblies 58 are guided by the slots 92 in the predetermined oblique orientation that is oblique to each of the mounting interface 35 and the cable interface 37. The oblique orientation can therefore be oblique to the surface of the substrate 22 to which the electrical connector 24 is mounted. The leadframe assemblies 58 can be oriented substantially parallel to each other when supported by the connector housing 34. Alternatively, the leadframe assemblies 58 can be oblique to each other when supported by the connector housing 34.

As a result, a length of the electrical contacts 36 can extend along paths 63 from the respective cable attachment ends 31 toward the respective mounting ends 39. The paths 63 can, but are not required to, extend from the respective cable attachment ends 31 to the respective mounting ends 39. The paths 63 can be substantially straight linear paths. Alternatively, the paths 63 could have any desired shape such as bent, curved, twisted, angled, or bowed. The electrical contacts 36 of each row can be substantially parallel to each other. Thus, each row of electrical contacts 36 can be said to extend along respective paths 63. That is, each of the rows of electrical contacts can define a respective slope of the paths 63 of the electrical contacts 36 that are disposed in the rows. The electrical contacts 36 can extend along the paths 63 along at least a majority up to an entirety of their respective lengths. The paths 63 can be substantially straight linear paths. The straight paths 63 can be oblique to each of the mounting interface 35 and the cable interface 37. Thus, the straight paths 63 can be oblique to each of the exterior surface 41 of the cable support body 54 and the exterior surface 43 of the housing body 52. Further, the straight paths 63 can be oblique to the surface of the substrate 22 to which the electrical connector 24 is mounted. Thus, the straight paths 63 are oblique to each of the longitudinal direction L and the transverse direction T. For instance, the electrical contacts 36 can extend down toward the mounting interface 35 as they extend forward away from the cable interface 37. The electrical contacts 36 of each individual leadframe assembly 58, and thus of each row, can be oriented substantially parallel to each other along the respective straight paths 63. Further, respective slopes of the paths 63 relative to the longitudinal direction L of the rows of electrical contacts 36 can be oriented substantially parallel to each other. Alternatively, as will be described in more detail below, a respective slope of the path 63 relative to the longitudinal direction L of at least one or more up to all of the rows of electrical contacts 36 can be different than the slopes of the paths 63 relative to the longitudinal direction L of all others of the rows of electrical contacts 36.

The electrical signal contacts 76 can be arranged such that respective straight lines oriented along the paths 63 of the electrical contacts pass through a majority of a length of the electrical signal contacts 76. Further, the straight lines pass substantially through respective geometric centers of the respective electrical signal contacts 76 along the majority of the length of the electrical signal contacts 76. The geometric centers are determined at a given location of the electrical signal contact 76 as being central in a cross-section of the signal contact 76 along a plane that is oriented perpendicular to the respective signal contact at the given location. For example, the geometric centers for one location of the electrical signal contact can be the central point in a cross-section taken along a plane including line A-A in FIG. 5A. Further, the straight lines extend substantially through one or both of the mounting ends 39 and the cable attachment ends 31 of the respective electrical signal contacts. For instance, the straight lines can extend substantially through the geometric centers of one or both of the mounting ends 39 and the cable attachment ends 31 of the respective electrical signal contacts.

The connector housing 34 can further include at least one support rib 96 that extends from the first side wall 86 to the second side wall 87 along the lateral direction A. The support rib 96 can be disposed adjacent respective ones of the slots 92. Further, the support rib 96 can be disposed in respective plane that is oriented parallel to the oblique direction of the slots 92, and thus also parallel to the oblique orientation of the leadframe housings 60 and the paths 63 defined by the electrical contacts 36. Thus, the support rib 96 avoids interfering with the leadframe assemblies 58 inserted into, and disposed in, the slots 92. The support rib 96 defines opposed major surfaces 98. In some examples, the leadframe assemblies 58 can be guided along one of the major surfaces 98 as they are inserted into the slots 92. The end walls 84 can also define a respective major surface 98.

While the support members 90 can be configured as slots 92 as described above in one example, it is recognized that the support members 90 can be alternatively configured in any manner as desired. For instance, the support members 90 can alternatively be configured as rails that are received in the leadframe assembly 58, such as, for example, slots in the leadframe housing 60. Thus, one of the connector housing 34 and the leadframe assemblies 58 can define a slot, and the other of the connector housing 34 and the leadframe assemblies 58 can be received in the slot such that the connector housing 34 supports the leadframe assemblies 58.

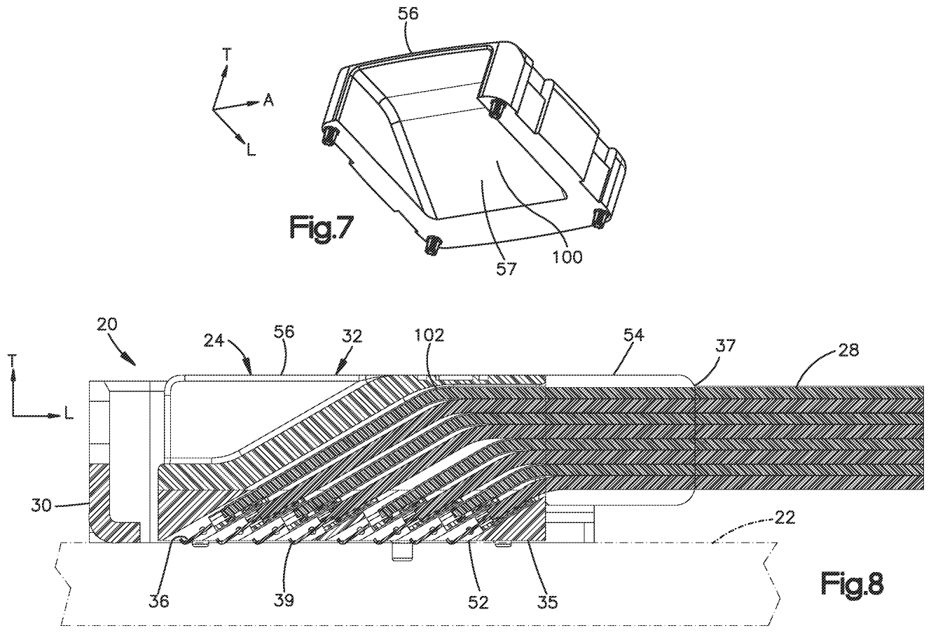

Referring now to FIGS. 7-8, the electrical cables 28 can further extend along respective second paths 65 that are substantially parallel to the paths of the electrical contacts 36 in the connector housing 34. In this regard, the paths 63 of the electrical contacts 36 can be referred to as first paths. The second paths 65 can therefore be oriented along a respective direction that is also oblique to each of the longitudinal direction L and the transverse direction T. For instance, the second paths 65 can extend down toward the mounting interface 35 as they extend forward away from the cable interface in the connector housing 34. The electrical cables 28 can be oriented along the longitudinal direction L as they extend through the cable support body 54. Alternatively, the electrical cables 28 can be oriented along a direction oblique to the longitudinal direction L as desired. The electrical cables 28 of each row can be substantially parallel to each other. Thus, each row of electrical cables 28 can be said to extend along respective second paths 65. That is, each of the rows of electrical cables 28 can define a respective slope of the second paths of the electrical cables 28 that are disposed in the rows. When the first and second paths 63 and 65 of an electrical contact 36 and an electrical cable 28 mounted to the electrical contact 36 are parallel or substantially coincident with each other, the first and second path 63 and 65 of the electrical contact 36 and the electrical cable 28 mounted to the electrical contact 36 can combine to define a combined path. Thus, in some examples, the rows of first and second paths 63 and 65 can combine to define rows of combined paths.

The cable guide body 56 can include a ramp 57 that defines an inclined internal surface 100 that is oriented oblique to each of the longitudinal direction L and the transverse direction T. In one example, the top exterior surface 45 of the housing body 52 can define an opening, and the cable guide body 56 can be configured as a cover that extends along the opening. The opening can be defined by each of the end walls 84 and side walls 86 and 87 of the housing body 52. In one example, the cable guide body 56 can be separate from and attached to the housing body 52. Alternatively, the cable guide body 56 can be monolithic with the housing body 52. At least some of the electrical cables 28, such as outermost or uppermost ones of the electrical cables 28, can about the inclined internal surface 100, such that the internal surface 100 directly guides those electrical cables that abut the internal surface 100 to extend to the cable attachment ends 31 along the respective second paths 65. The electrical cables 28 that are in direct abutment with the internal surface 100 can guide the other ones of the electrical cables 28 to extend along the respective second paths 65.

The second paths 65 of the electrical cables 28 can be defined at the respective cable attachment ends 31. In other examples, the second paths 65 can extend from the respective cable attachment ends 31, to respective elbows 102 defined by the electrical cables. The electrical cables can extend from the respective elbows 102 through the cable support body 54 substantially along the longitudinal direction L. Thus, the electrical cables 28 can extend from the elbows 102 to the cable attachment ends 31 along the second path that is sloped downward as it extends along the longitudinal direction. The second paths 65 can be within approximately +/−30 degrees (i.e., up to 30 degrees greater than or 30 degrees less than) of the first path with respect to a view along the lateral direction A. For instance, the second paths 65 can be within approximately +/−20 degrees of the first path. In one example, the second paths 65 can be within approximately +/−10 degrees of the first path. Thus, the second paths 65 can be substantially parallel to the first paths 63. In some examples, the second paths 65 can be substantially coincident with the first paths 63. In particular, the electrical cables 28 can extend from the respective cable attachment ends 31 along the second paths 65.

The second paths 65 of the cables 28 of each row can be substantially parallel to each other. Thus, each row of electrical cables 28 can be said to extend along respective second paths 65. Further, respective slopes of the second paths 65 relative to the longitudinal direction L of the rows of electrical cables 28 can be oriented substantially parallel to each other. Alternatively, as will be described in more detail below, the respective slopes of the second path 65 with respect to the longitudinal direction L of at least one or more up to all of the rows of electrical cables 28 can be different than the slopes of the second paths 65 with respect to the longitudinal direction L of all others of the rows of electrical cables 28.

The first paths 63 can define any suitable slope or angle with respect to the longitudinal direction L as desired. As described above, both the surface of the substrate 22 to which the electrical connector 24 may be mounted and the mounting interface 35 of the electrical connector 24, and thus the bottom exterior surface 43 of the connector housing 34, can be oriented substantially along the longitudinal direction L. Thus, the angle defined by the first paths 63 with respect to the longitudinal direction L is also with respect to both the surface of the substrate 22 when the electrical connector 24 is mounted to the surface of the substrate 22, and the mounting interface 35 of the electrical connector 24, and thus the bottom exterior surface 43 of the connector housing 34. In one example, the angle can be in a range from approximately 10 degrees to approximately 80 degrees, such as from approximately 20 degrees to approximately 70 degrees. For instance, the angle can be in a range from approximately 30 degrees to approximately 60 degrees. In particular, the angle can be in a range from approximately 40 degrees to approximately 50 degrees. In one particular example, the angle can be approximately 45 degrees. The first paths 63 defined by the electrical contacts of a plurality of the rows of the electrical contacts 36 up to all of the rows of the electrical contacts 36 can be substantially parallel to each other.

A height of the electrical connector 24 may be measured in the transverse direction. The first paths 63 and second paths 65 defined by the electrical contacts 26 and the electrical cables 28, respectively, can influence the height of the electrical connector 24. It is appreciated that the first paths 63 and second paths 65 defined by the electrical contacts 26 and the electrical cables 28, respectively, allow the electrical contacts to extend away from the substrate 22 a given length while reducing the height of the electrical connector 24 along the transverse direction compared to conventional electrical connectors whose electrical contacts are oriented perpendicular to the substrate and extend from the substrate the same length. For example, the electrical connector height may be measured at a select distance away from an end of the electrical contacts 26 in the longitudinal direction. The height of the electrical connector 24 can be smaller than the height of conventional electrical connectors when both heights are measured at the select distance away from the end of their respective electrical contacts 26.

Further, the electrical cables 28 that extend through the connector housing 34 can be spaced from the substrate along the transverse direction a distance less than electrical cables of conventional electrical connectors whose electrical contacts are right-angle contacts that extend perpendicularly away from the substrate, and then bend to an orientation that is parallel to the substrate. In one example, the electrical connector 24 can include up to sixty-four differential signal pairs in a 600 square mm footprint. That is, the electrical connector 24, including the shroud 30 and the housing assembly 32, occupy no more than 600 square mm on the substrate 22. The footprint may be defined along a plane that includes the longitudinal direction L and the lateral direction A. In some examples, the housing assembly 32 can have a footprint of no more than 600 square mm.

Further, in some examples, the electrical connector 24 extends from the substrate 22 along the transverse direction a height of no more than approximately 15 mm, such as no more than approximately 14 mm, such as no more than approximately 13 mm, such as no more than approximately 12 mm, such as no more than approximately 11 mm, such as no more than approximately 10 mm, such as no more than approximately 9 mm, such as no more than approximately 8 mm, such as no more than approximately 7 mm, such as no more than approximately 6 mm. The electrical connector 24 can define the height along the transverse direction from the bottom exterior surface 43 to the top exterior surface 45.

The electrical cables 28 can extend in the rearward direction out of the connector housing 34. For instance, the electrical cables 28 can extend along respective third paths 67 from the respective elbows 102. The third paths 67 can be oblique to the respective second paths 65 defined by the electrical cables 28. For instance, the third path 67 can be oriented generally along the longitudinal direction L, though it is appreciated that the third path 67 can extend in any direction as desired as the electrical cables 28 are routed to a complementary electrical device. In this regard, it should be appreciated that any of the first, second, and third paths 63, 65, 67 can be substantially linear, but can be slightly curved as desired so as to route the electrical cables 28 away from the respective electrical contacts 36.

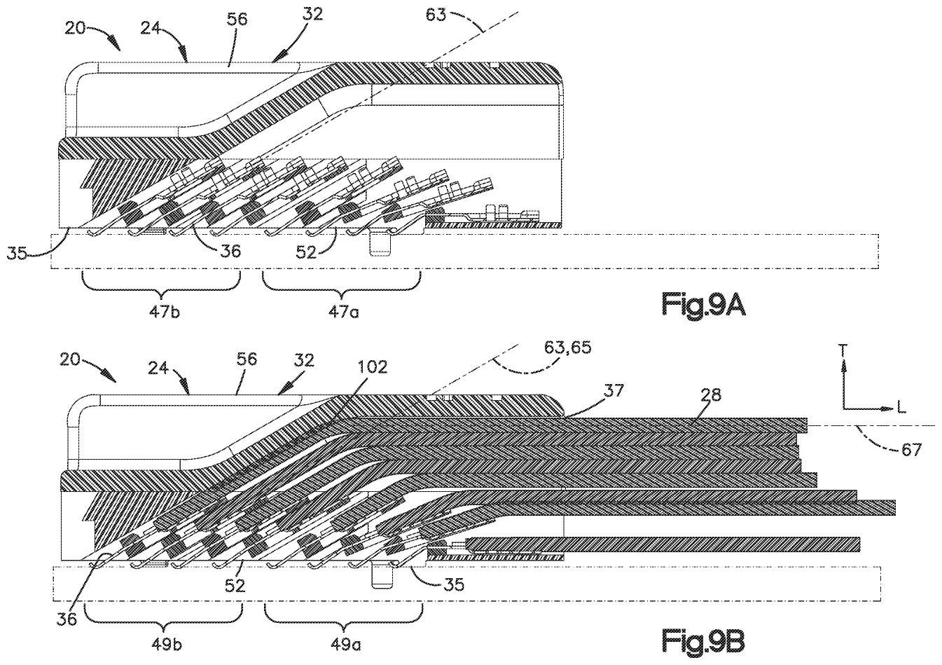

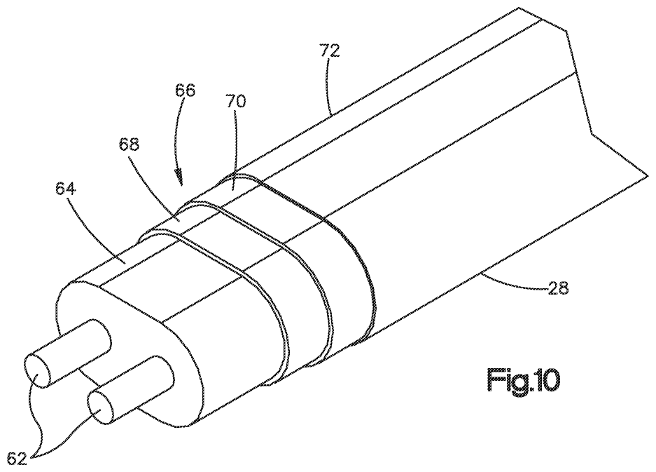

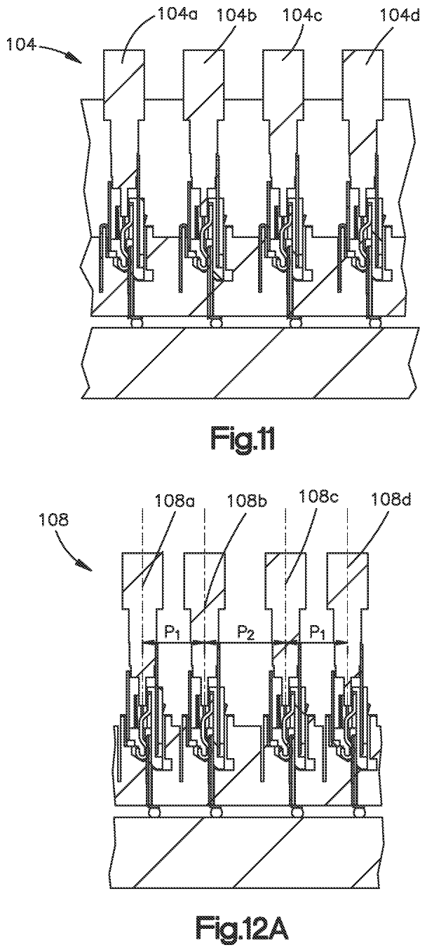

Referring now to FIG. 9A, it is recognized that the height of the electrical connector 24 can be further reduced. In particular, respective slopes of the first paths 63 and second paths 65 defined by the rows of electrical contacts 36 and electrical cables 28, respectively, can vary among respective electrical contacts 36 and cables 28 spaced from each other along the longitudinal direction L. For instance, the angle defined by the first paths 63 of electrical contacts 36 with respect to the longitudinal direction L can be greater than that of other electrical contacts 36 spaced therefrom in the rearward direction. Accordingly, the first path of a first electrical contact can define a first slope with respect to the longitudinal direction L, and the first path of a second electrical contact can define a second slope with respect to the longitudinal direction L that is less than the first slope. The second electrical contact can be spaced from the first electrical contact in the rearward direction. In some examples, the respective first paths 63 of a plurality of electrical contacts 36 (or rows of electrical contacts 36) sequentially spaced from each other in the rearward direction can define progressively decreased slopes with respect to the longitudinal direction L.

The sequentially spaced electrical contacts whose first paths 63 define progressively decreased slopes with respect to the longitudinal direction L can define a rear group 47a of one or more electrical contacts 36 (or a rear group of rows of electrical contacts 36). The slope of the first paths 63 of the electrical contacts 36 of the rear group 47a with respect to the longitudinal direction L can vary among electrical contacts 36 that are spaced from each other along the longitudinal direction. In one example, the first path of a rearmost electrical contact 36 (or rearmost row of electrical contacts) of the rear group 47a can extend substantially along the longitudinal direction L (including the rearward direction and the forward direction). The first path of an electrical contact 36 (or row of electrical contacts 36) of the rear group 47a that is disposed immediately adjacent the rearmost electrical contact 36 (or rearmost row of electrical contacts) in the forward direction can be oblique with respect to the longitudinal direction L, and thus define a greater slope than the rearmost electrical contact 36 (or row of electrical contacts 36).

The electrical contacts 36 (or rows of electrical contacts) can define a forward group 47b of one or more electrical contacts 36 (which can be arranged in a plurality of forward rows of electrical contacts) that are spaced from the rear group 47a of electrical contacts 36 (or rear group of rows of electrical contacts) in the forward direction. The first paths 63 defined by the electrical contacts 36 of the forward group 47b can be sloped with respect to the longitudinal direction greater the first paths 63 defined by the electrical contacts 36 of the rear group 47a. Further, the first paths 63 defined by the electrical contacts 36 of the forward group 47b can be substantially parallel to each other. The connector 24 can include a third group and/or a fourth group of electrical contacts 36. The first paths 63 of the third group may be sloped with respect to the longitudinal direction that is different from (e.g., less than) the first paths 63 defined by the electrical contacts 36 of the forward group 47b. The first paths 63 of the third group may be sloped with respect to the longitudinal direction that is different from (e.g., greater than) the first paths 63 defined by the electrical contacts 36 of the rear group 47a. The first paths of the fourth group may be sloped with respect to the longitudinal direction that is different from the first paths 63 defined by one or more of the forward group 47b, the rear group 47a, or the third group. Two or more of the forward group 47b, rear group 47a, third group, and fourth group may have the same slope with respect to the longitudinal direction.

Referring now to FIG. 9B, the description of the second paths 65 defined by the electrical cables 28 can be configured as described with respect to the first paths 63 defined by the electrical contacts 36 of FIG. 9A. Thus, the second paths 65 can define any suitable slope or angle as described above with respect to the first paths 63. For instance, the angle defined by the second paths 65 of electrical cables 28 (and thus also the combined paths) with respect to the longitudinal direction L can be greater than that of other cables 28 spaced therefrom in the rearward direction. Accordingly, a first one of the second paths 65 or combined paths can define a first slope with respect to the longitudinal direction L, and a second one of the second paths or combined paths can define a second slope with respect to the longitudinal direction L that is less than the first slope. The second one of the second paths 65 or combined paths can be spaced from the first one of the second paths 65 or combined paths in the rearward direction. In some examples, the respective first paths 63 and second paths 65 can be sequentially spaced from each other in the rearward direction and can define progressively decreased slopes with respect to the longitudinal direction L. In one example, all electrical contacts 36 of a common one of the rows can extend along the same first path 63. Similarly, all electrical cables 28 of a common one of the rows can extend along the same second path 65.

Sequentially spaced electrical cables 28 in the rearward direction whose second paths 65 define progressively decreased first slopes with respect to the longitudinal direction L can define a rear group 49a of cables 28 (or a rear group of rows of cables 28). The slope of the second paths 65 of the electrical cables 28 of the rear group with respect to the longitudinal direction L can thus vary among electrical cables 28 that are spaced from each other along the longitudinal direction. In one example, the second path of a rearmost electrical cable 28 (or rearmost row of electrical cables 28) of the rear group can extend substantially along the longitudinal direction L. The second path of an electrical cable 28 (or row of electrical cables 28) of the rear group that is disposed immediately adjacent the rearmost electrical cable 28 (or rearmost row of electrical cables 28) in the forward direction can be oblique with respect to the longitudinal direction L, and thus define a greater slope than the rearmost electrical cable 28 (or row of electrical cables 28).

The electrical cables 28 (or rows of electrical cables 28) can define a forward group of electrical cables 49b (which can be arranged in a plurality of forward rows of electrical contacts) that are spaced from the rear group of electrical cables 49a (or rear group of rows of electrical cables 28) in the forward direction. The second paths 65 defined by the electrical cables 28 of the forward group can be sloped with respect to the longitudinal direction greater the second paths 65 defined by the electrical cables 28 of the rear group. Further, the second paths 65 defined by the electrical cables 28 of the forward group can be substantially parallel to each other.

In is recognized that the electrical connector 24 can include any number of rows of electrical contacts 36 and electrical cables 28 as desired. Thus, in some examples described above, some of the slopes defined by the rows of first paths 63 and rows of second paths 65 (and in some examples combined paths) can extend substantially parallel to each other. Others of the slopes defined by the rows of first paths 63 and rows of second paths 65 (and in some examples combined paths) be different from each other. For instance, the different slopes can decrease in the rearward direction. In still other examples, the slopes of all of the rows of first paths 63 and all of the rows of second paths 65 (and in some examples combined paths) can be different than each other. For example, the slopes of the rows with respect to the longitudinal direction L can decrease from row to row in the rearward direction.

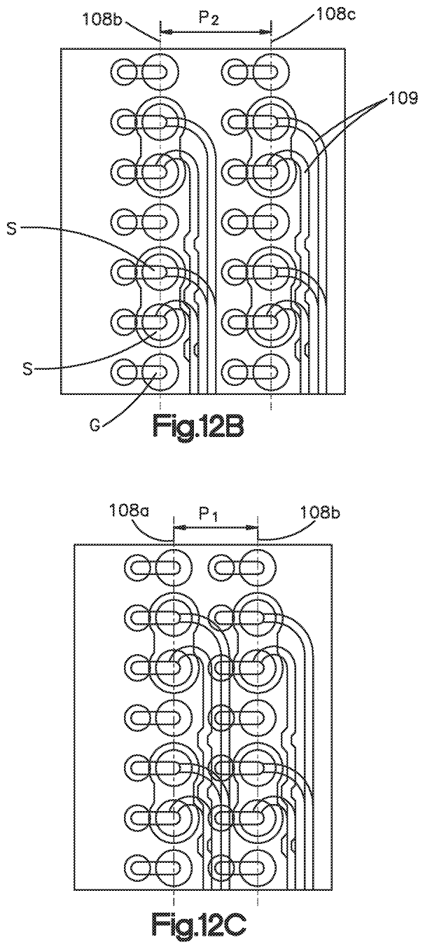

FIG. 11 shows a plurality of conventional mated connectors 104. The mated connectors can be ACCELERATE brand connectors commercially available from Samtec, Inc. having a principal place of business in New Albany, IN. The conventional mated connectors 104 can include a first conventional mated connector 104A, a second conventional mated connector 104B, a third conventional mated connector 104C, and a fourth conventional mated connector 104D. The conventional mated connectors 104 can have a conventional outer jacket such that, a first row or column or linear array center-to-center spacing or pitch between the first conventional mated connector 104A and the second conventional mated connector 104B can be about 2.4 mm. The pitch between the second conventional mated connector 104B and the third conventional mated connector 104C can be about 2.2 mm. The pitch between the third conventional mated connector 104C and the fourth conventional mated connector 104D can be about 2.4 mm.

In contradistinction, FIGS. 12A-12C show a plurality of mated connectors 108 that can have a smaller footprint than the conventional mated connectors 104. The mated connectors 108 can be modified ACCELERATE brand connectors, modified ACCELERATE HP brand connectors (described below), modified ACCELERATE HD brand connectors, modified ADM6/ADF6 brand connectors, all commercially available from Samtec, Inc., or any other type of connector. A cable connector of the mated connectors 108 can be modified with smaller diameter or height twinax, or thinner twinax, as described herein and shown in connection with FIGS. 5A-5F and FIG. 10. As described above, the mated connectors 108 having smaller diameter or height twinaxial cables, or thinner twinaxial cables whose outer electrically insulative jacket can be configured as electrically insulative tape as described above, can define a second row or column or linear array. As previously discussed, the mated connectors 108 can have a repeating S-S-G pattern, wherein “S” designates a signal contact, and “G” designates a ground contact (FIG. 12B). One or more traces 109 may electrically connect the mated connectors 108 to another component. The traces 109 may overlap as routing layers.

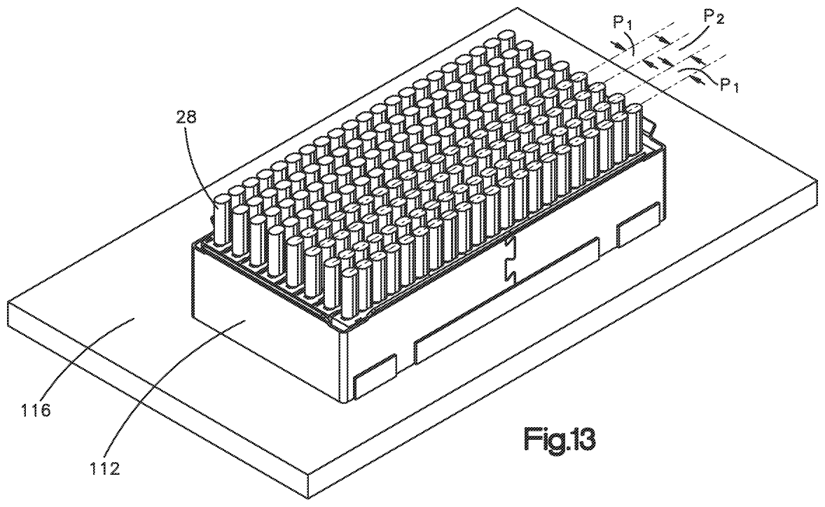

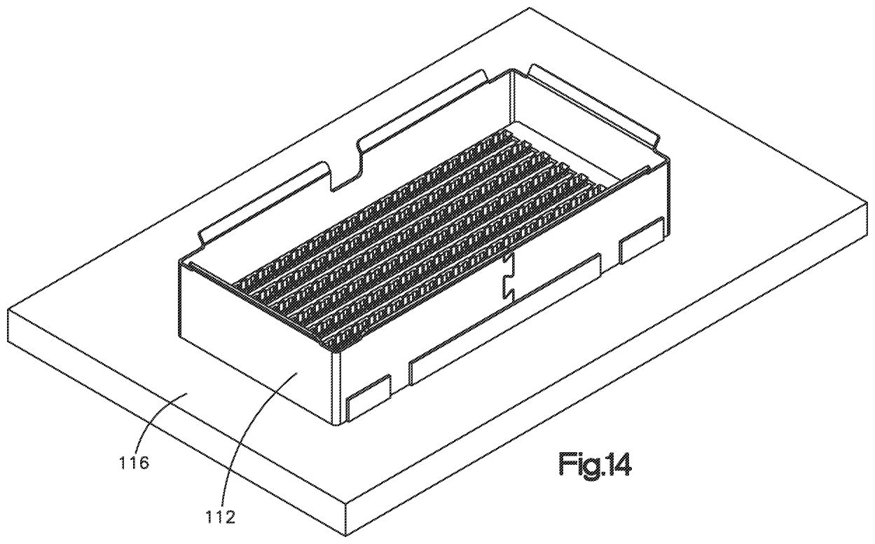

The mated connectors 108 can include a first mated connector 108A, a second mated connector 108B, a third mated connector 108C, and a fourth mated connector 108D. The mated connectors 108 can have a row or column or linear array center-to-center spacing or pitch that is reduced with respect to the connector shown in FIG. 11. Referring to FIGS. 12B, 12C, and 13, the pitch P₁ between the first mated connector 108A and the second mated connector 108B can be about 1.1 mm. The pitch P₂ between the second mated connector 108B and the third mated connector 108C can be about 1.5 mm. The pitch between the third mated connector 108C and the fourth mated connector 108D can be the same as pitch P₁. Pitch P₁ can be less than pitch P₂.

The associated or corresponding PCB footprint of mated connectors 108 can be approximately 25%, approximately 35%, greater than 10%, or greater than 20% smaller than the PCB footprint of conventional mated connectors 104, which improves density and maintains pin structure without significantly degrading signal integrity. The same number of routing layers, such as six routing layers, can be used by employing HDI-like (high density interconnect) technologies on a denser second row-to-row, column-to-column, or linear array-to-linear array pitch.

The mated connectors 108 can be ACCELERATE HP connectors that are modified as disclosed herein to include the above-described electrically insulation that defines the outer jacket of the electrical cables and thus allowing an increased electrical contact or electrical conductor density. Conductor center-to-center pitch can be approximately 0.6 mm, approximately 0.63 mm, or approximately 0.635 mm. Each connector of the two mated connectors 108 can included twelve (12) rows of electrical contacts or electrical conductors. The respective cable connector can include twelve (12) twinaxial cables per row.

Referring now to FIGS. 13-15, in another example an electrical connector assembly can include a receptacle connector 112 and at least two direct attach cable connectors 114 that are configured to mate with the receptacle connector 112. The receptacle connector 112 can be mounted to a substrate 116, such as a die package substrate or a host substrate. The substrate 116 can be configured as a printed circuit board in one example. Each of the at least two direct attach cable connectors 114 can plug into or onto the receptacle connector 112. Each cable connector 114 can include a cable constructed according to the description of FIGS. 5A-5F and FIG. 10, whereby the outer electrically insulative jacket of the electrical cables is defined by tape.

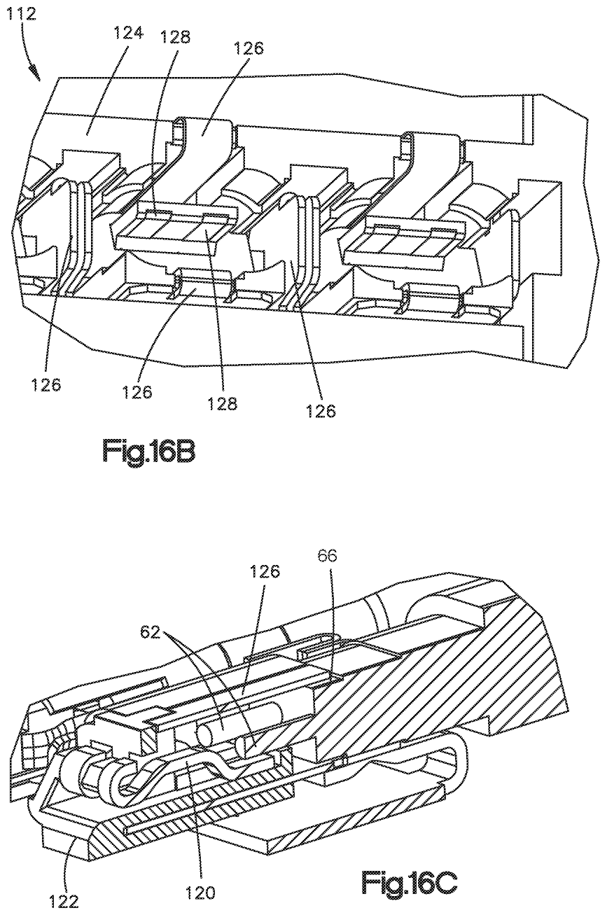

Continuing to FIG. 16A, each direct attach cable connector 114 can further include a cable shield 118, at least one or at least two cable mating conductors 120, and a cable housing 122. The cable shield 118 can provide 360 degree shielding around the at least one or at least two cable mating conductors 120 and can be electrically grounded to the electrical shield 66 of the electrical cable 28. The cable shield 118 and each of the at least one or at least two cable mating conductors 120 can be made from metal or other electrically conductive material. The at least two cable mating conductors 120 can define a differential signal pair. The cable housing 122 can carry any one or more of the at least one or at least two cable mating conductors 120, the cable shield 118, and the and the electrical cable 28. The mating conductors 120 can be copper, copper alloy, or phosphorus bronze and can be devoid of superelastic materials such as nitinol (NiTi).

FIG. 16B generally shows the receptacle connector 112. The receptacle connector 112 can include a receptacle housing 124, a receptacle shield 126, and at least one or at least two receptacle mating conductors 128. The receptacle housing 124 can be made from an electrically insulative material. The receptacle shield 126 can be made from an electrically conductive material. The at least one or at least two receptacle mating conductors 128 can each be configured to be press-fit, through hole or SMT mounted to a substrate and can both be made from an electrically conductive material.

The receptacle shield 126 can be configured to electrically contact, physically contact, or both, a respective cable shield (66; FIG. 16A). Each of the at least one or at least two cable mating conductors 120 can be configured to mate with a respective one of the at least one or at least two receptacle mating conductors 128. The receptacle shield 126 can include a first pair of opposed shields spaced from each other along a first direction, and a second pair of opposed shields spaced from each other along a second direction perpendicular to the first direction. The first and second directions can each be perpendicular to the mating direction of the receptacle connector 112. The pair of mating conductors 128 can be disposed between the shields of the first pair of opposed shields, and can further be disposed between the shields of the second pair of opposed shields. The shields of the first and second pairs of opposed shields can be spaced from each other in a plane that is defined by the first and second directions.

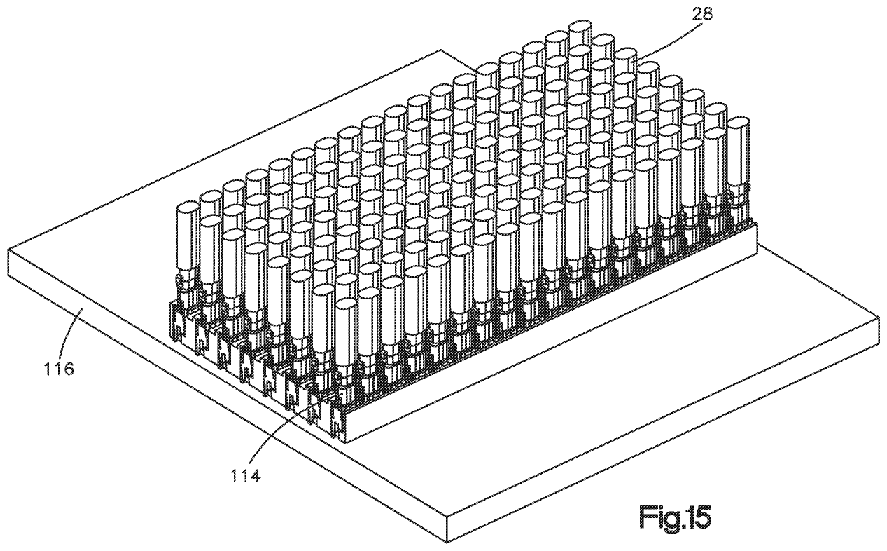

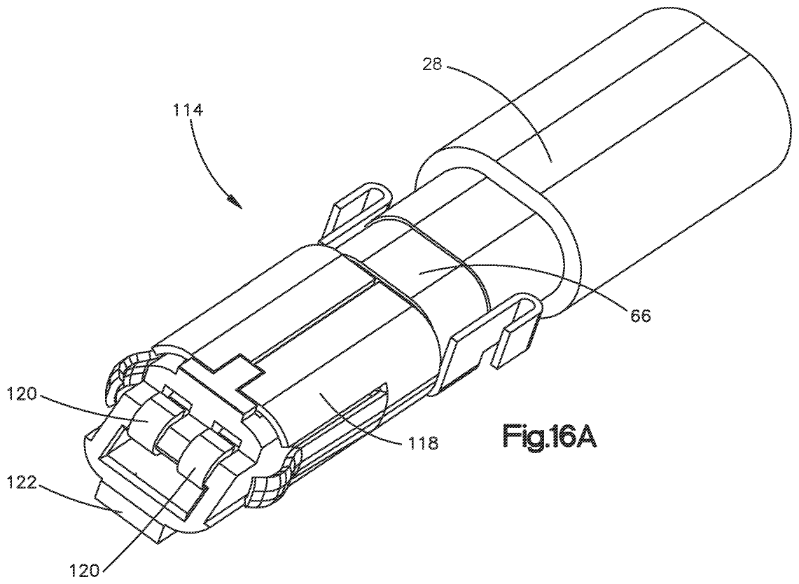

In general, the electrical cable connector 114 can carry electrical cables 28, such as twinaxial cables. Two parallel, adjacent rows of twinaxial cables can be spaced apart by an approximate 1.1 mm or an approximate 1.5 mm row/colunm/linear array pitch P₃ (FIG. 15). Each of the twinaxial cables can carry at least two conductors, the pair of cable mating conductors 120, or both. A cable shield can extend approximately 360 degrees around the at least two conductors or the pair of cable mating conductors 120. The electrical cable connector 114 can be configured to be plugged into or onto a corresponding receptacle connector 112.

It should be noted that the illustrations and discussions of the embodiments shown in the figures are for exemplary purposes only, and should not be construed limiting the disclosure. One skilled in the art will appreciate that the present disclosure contemplates various embodiments. For instance, it should be appreciated that while the second paths were described in connection with electrical cables 28. Alternatively, optical cables may be used in place of or in combination with electrical cables that extend from a transceiver or alternative device along the second paths as described above. Additionally, it should be understood that the concepts described above with the above-described embodiments may be employed alone or in combination with any of the other embodiments described above. It should further be appreciated that the various alternative embodiments described above with respect to one illustrated embodiment can apply to all embodiments as described herein, unless otherwise indicated.

1-76. (canceled)

77. An electrical cable connector that carries twinaxial cables, wherein two parallel, adjacent rows of twinaxial cables are spaced apart by approximate 1.1 mm pitch.

78. An electrical cable connector that carries twinaxial cables, wherein two parallel, adjacent rows of twinaxial cables are spaced apart by approximate 1.5 mm pitch.

79. An electrical cable connector of claim 78, wherein each of the twinaxial cables carries a pair of cable mating conductors.

80. The electrical cable connector of claim 79 wherein the electrical cable connector further comprises a cable shield that extends approximately 360 degrees around the pair of cable mating conductors.

81. The electrical cable connector of claim 78, wherein the electrical cable connector is configured to be plugged into or onto a corresponding receptacle connector.

82. The electrical cable connector of claim 81, wherein the corresponding receptacle connector comprises a shroud configured to be mounted to a substrate.

83. An electrical connector comprising:
a connector housing having a mounting interface that is configured to face an underlying substrate, and a cable interface oriented obliquely relative to the mounting interface, wherein a plurality of electrical cables are configured to exit the cable interface,
a plurality of electrical contacts supported by the connector housing, the electrical contacts having respective mounting ends configured to be mounted to the substrate, and cable attachment ends configured to attach to electrical cables, respectively,
wherein the electrical contacts extend along respective first paths from the respective mounting ends to the respective cable attachment ends, and the first paths are oblique to each of the mounting interface and the cable interface.

84-142. (canceled)

143. An electrical cable connector of claim 77, wherein each of the twinaxial cables carries a pair of cable mating conductors.

144. The electrical cable connector of claim 143, wherein the electrical cable connector further comprises a cable shield that extends approximately 360 degrees around the pair of cable mating conductors.

145. The electrical cable connector of claim 77, wherein the electrical cable connector is configured to be plugged into or onto a corresponding receptacle connector.

146. The electrical cable connector of claim 145, wherein the corresponding receptacle connector comprises a shroud configured to be mounted to a substrate.
